(19) United States
(12) Patent Application Publication
(10) Pub. No.: US 2025/0149604 A1
(43) Pub. Date: May 8, 2025

(54) Method and Device for Ascertaining the Oxidizing Agent Mass Flow in an Electrochemical Energy Converter

(71) Applicant: Bayerische Motoren Werke Aktiengesellschaft, Muenchen (DE)

(72) Inventors: Maximilian Karl EISNER, Muenchen (DE); Volker FORMANSKI, Ismaning (DE); Zheng ZHOU, Fuerstenfeldbruck (DE)

(21) Appl. No.: 18/837,254

(22) PCT Filed: Feb. 3, 2023
(86) PCT No.: PCT/EP2023/052703

§ 371 Date: Aug. 9, 2024

(30) Foreign Application Priority Data
Feb. 10, 2022 (DE) 10 2022 103 159.4

(51) Int. Cl. H01M 8/0438; G01F 1/86; H01M 8/04111; H01M 8/0432; H01M 8/04746; H01M 8/04992

(52) U.S. Cl. CPC H01M 8/04395; G01F 1/86; H01M 8/04111; H01M 8/04335; H01M 8/04373; H01M 8/04425; H01M 8/04753; H01M 8/04776; H01M 8/04992; H01M 2250/20

(57) ABSTRACT

A device for ascertaining an estimated value of the mass flow of an oxidizing agent into an electrochemical energy converter is provided, the oxidizing agent mass flow being produced by an oxidizing agent conveyor. The device is designed to detect temperature and pressure measurement values on an oxidizing agent path to the energy converter using temperature and pressure sensors. The oxidizing agent conveyor is arranged on the oxidizing agent path. The device is additionally designed to ascertain an estimated value of the oxidizing agent mass flow conveyed by the oxidizing agent conveyor, in particular an estimated value of the oxidizing agent mass flow flowing into the energy converter, on the basis of the temperature and pressure measurement values using a base estimation model.

### BACKGROUND AND SUMMARY

The technology disclosed herein relates to a method and to a corresponding apparatus for ascertaining the oxidant flow rate into an energy converter, especially into a fuel cell stack.

An electrically driven vehicle may have a fuel cell stack with one or more fuel cells that is configured to generate electrical energy for operation of the electrical engine of the vehicle on the basis of a fuel, especially on the basis of hydrogen. The fuel for the fuel cell stack is typically routed from a pressure vessel to the fuel cell stack. It is possible here to vary the amount of fuel supplied to the fuel cell stack by means of a valve.

In addition, the fuel cell stack is typically supplied with an oxidant, especially ambient air. The oxidant may be fed to the fuel cell stack via a compressor, where the amount of oxidant supplied may be altered via the delivery capacity of the compressor, for example in order to vary the electrical output of the fuel cell.

Precise open-loop and/or closed-loop control of the electrical power provided by the fuel cell stack typically requires precise open-loop and/or closed-loop control of the volume flow rate and/or mass flow rate of oxidant which is fed to the fuel cell stack. In this connection, it is possible to use a physical mass flow rate sensor in order to ascertain the actual mass flow rate of oxidant. However, the sensor data from a physical mass flow sensor, especially in the case of relatively high mass flow rates, may be subject to a relatively high level of noise, which can lead to inaccuracy in the closed-loop control of the volume flow rate and/or mass flow rate, to mechanical stress on the compressor and/or to impairment of the electrical power provided by the fuel cell stack.

It is a preferred object of the technology disclosed here to reduce or to remedy at least one disadvantage of a previously known solution or to propose an alternative solution. It is a preferred object of the technology disclosed here to efficiently make a precise estimate of the actual mass flow rate of oxidant into an energy converter, especially into a fuel cell stack.

The object(s) is/are achieved by the subject matter of the independent claims. The dependent claims are preferred configurations.

In one aspect, an apparatus for estimating a mass flow rate of oxidant (e.g. air) into an electrochemical energy converter (especially into a fuel cell stack) is described. The oxidant mass flow may be brought about by an oxidant conveyor (especially by a compressor). The oxidant conveyor is disposed on an oxidant pathway from an inlet for oxidant up to a feed to the energy converter. In a specific example, the oxidant pathway is part of a cathode subsystem of a fuel cell stack.

The apparatus is configured to use temperature and pressure sensors to detect temperature and pressure measurements on the oxidant pathway to the energy converter. The temperature and pressure measurements may include: a pressure measurement of the pressure at the input of the oxidant conveyor; a pressure measurement of the pressure at the output of the oxidant conveyor; and/or a temperature measurement of the temperature at the input of the oxidant conveyor.

The apparatus is also configured to use the temperature and pressure measurements as a basis, using a base estimation model, for estimation of the oxidant mass flow rate conveyed by the oxidant conveyor, especially an estimated oxidant mass flow rate flowing into the energy converter.

The base estimation model may be dependent on one or more properties of the oxidant conveyor. The one or more properties of the oxidant conveyor may include, for example: the rotation velocity and/or the speed of rotation of the rotor of the oxidant conveyor (which can be detected by an appropriate sensor); and/or the cross section and/or diameter of the oxidant conveyor. Alternatively or additionally, the base estimation model may include one or more fitting parameters for which parameter values have been ascertained (possibly solely) using measurements at the oxidant conveyor.

It is thus possible to provide a base estimation model for the oxidant conveyor that has been parametrized beforehand (on the basis of measurements on a test bed of the oxidant conveyor). The base estimation model may comprise an analytical model (as described in this document). Alternatively or additionally, the base estimation model may comprise a machine-learned model (for example with one or more artificial neural networks).

Using the base estimation model (independently of and/or in addition to a physical mass flow rate sensor), it is possible to estimate the oxidant mass flow rate. As described in this document, it is possible here to estimate a value \dot{m}_{Cmpr} of the mass flow rate conveyed by the oxidant conveyor 205 and/or a value \dot{m}_{Kat} of the oxidant mass flow rate flowing into the energy converter. For this purpose, it is possible to use the base estimation model described in this document at least in part or in full. In this way, it is possible in an efficient and precise manner to estimate the oxidant mass flow rate, which has a relatively high signal-to-noise ratio (by comparison with a physical mass flow rate sensor).

The apparatus may be configured to operate the oxidant conveyor depending on the estimated oxidant mass flow rate, especially in order to adjust the oxidant mass flow rate to a target value (for example by closed-loop control). Alternatively or additionally, the apparatus may be configured to verify (for example to plausibilize) the mass flow rate measurement from a physical mass flow rate sensor on the oxidant pathway using the estimated oxidant mass flow rate. It is thus possible to increase the quality of adjustment of the oxidant mass flow rate for an energy converter, by means of which it is possible to increase the power dynamics of the energy converter.

The apparatus may be configured to detect current temperature and pressure measurements repeatedly at a sequence of timepoints, especially periodically (for example with a frequency of 1 Hz or more, or 10 Hz or more, or 100 Hz or more), and on that basis to make a current estimate each time of the oxidant mass flow rate being conveyed by the oxidant conveyor, especially a current estimate each time of the oxidant mass flow rate flowing into the energy converter. In this way, it is possible to enable permanently precise ascertainment of the oxidant mass flow rate.

The oxidant conveyor may comprise an (electric) motor having one or more motor bearings that are operated with oxidant that has been conveyed by the oxidant conveyor. The oxidant mass flow rate for operation of the one or more motor bearings may be branched off from a branch point between the output of the oxidant conveyor and the energy converter. In addition, the oxidant mass flow rate, for operation of the one or more motor bearings, may be fed back into the oxidant pathway at a feed point between the input of the oxidant conveyor and an oxidant filter (for filtering of the oxidant).

The apparatus may be configured to estimate the oxidant mass flow rate for operation of the one or more motor bearings on the basis of temperature and pressure measurements and using a supplementary estimation model. The supplementary estimation model may depend on the one or more temperature and pressure measurements and/or on one or more fitting parameters. The temperature and pressure measurements may comprise: a pressure measurement in relation to the pressure of the oxidant at the input of the one or more motor bearings; a pressure measurement in relation to the pressure of the oxidant at the output of the one or more motor bearings; and/or a temperature measurement in relation to the temperature of the oxidant at the input of the one or more motor bearings.

The supplementary estimation model may comprise an analytical model (as described in this document). Alternatively or additionally, the supplementary estimation model may comprise a machine-learned model. The parameter values of the one or more fitting parameters may have been ascertained by measurements. The supplementary estimation model can be used to ascertain the estimate \dot{m}_{AirBear} (as described in this document).

The apparatus may also be configured to estimate the oxidant mass flow rate flowing into the energy converter (especially \dot{m}_{Kat}) on the basis of the estimated oxidant mass flow rate for operation of the one or more motor bearings. The estimated oxidant mass flow rate flowing into the energy converter (especially \dot{m}_{Kat}) may especially be ascertained on the basis of the estimated oxidant mass flow rate conveyed by the oxidant conveyor (especially \dot{m}_{Cmpr}) and on the basis of the estimated oxidant mass flow rate for operation of the one or more motor bearings (especially \dot{m}_{AirBear}), for example on the basis of the difference between the two estimates, for instance as \dot{m}_{Kat}=\dot{m}_{Cmpr}−\dot{m}_{AirBear}. It is thus possible to estimate the oxidant mass flow rate flowing into the energy converter in a particularly precise manner.

Alternatively or additionally, the apparatus may be configured to measure the temperature of the oxidant at the input of the oxidant conveyor on the basis of a measurement of the motor temperature (which can be ascertained by means of a corresponding sensor in the motor). It is thus possible to take account of the fact that the oxidant is conveyed to the input of the oxidant conveyor by the one or more motor bearings (and heats the effective oxidant mass flow rate at the same time). The adjustment of the temperature measurement can be brought about by the formula described in this document.

The estimated oxidant mass flow rate conveyed by the oxidant conveyor (especially \dot{m}_{Cmpr}) can then be ascertained in a particularly precise manner on the basis of the measurement of the temperature of the oxidant at the input of the oxidant conveyor (especially on the basis of T_{Cmpr}ⁱⁿ).

In a further aspect, a fuel cell system is described, which comprises the apparatus described in this document.

In a further aspect, a motor vehicle (for road use) (especially a car or a truck or a bus or a motorcycle) is described, which comprises the apparatus described in this document and/or the fuel cell system described in this document.

In a further aspect, a method of estimating a mass flow rate of oxidant into an electrochemical energy converter is described, wherein the oxidant mass flow is brought about by an oxidant conveyor. The method comprises the making, by temperature and pressure sensors, of temperature and pressure measurements on an oxidant pathway to the energy converter on which the oxidant conveyor is disposed. In addition, the method comprises estimating, on the basis of the temperature and pressure measurements, using a base estimation model, an estimated oxidant mass flow rate conveyed through the oxidant conveyor, especially an estimated oxidant mass flow rate flowing into the energy converter.

In a further aspect, a software (SW) program is described. The SW program may be configured to be executed on a processor (for example on a vehicle controller), and in order to thereby execute the method described in this document.

In a further aspect, a storage medium is described. The storage medium may comprise an SW program configured to be executed on a processor, and in order thereby to execute the method described in this document.

It should be noted that the methods, apparatuses and systems described in this document may be used either alone or in combination with other methods, apparatuses and systems described in this document. In addition, any aspects of the methods, apparatuses and systems described in this document may be combined with one another in various ways. In particular, the features of the claims may be combined with one another in various ways. In addition, features adduced in brackets may be considered to be optional features. The invention is elucidated in detail hereinafter by working examples.

### BRIEF DESCRIPTION OF THE DRAWINGS

FIG. 1: an illustrative fuel cell system with a fuel cell stack;

FIG. 2: an illustrative construction of a fuel cell;

FIG. 3: an illustrative fuel cell stack in a side view;

FIG. 4: an illustrative fuel cell stack in a front view;

FIG. 5: an illustrative cathode subsystem of a fuel cell stack; and

FIG. 6: a flow diagram of an illustrative method of estimating the mass flow rate of oxidant into a fuel cell stack.

### DETAILED DESCRIPTION OF THE DRAWINGS

As set out at the outset, the present document is concerned with efficient and precise estimation of the oxidant mass flow rate to the cathode of a fuel cell stack. There follows a specific discussion of a fuel cell stack and a cathode subsystem having a compressor. It should be pointed out that the aspects described are applicable generally to an energy converter and/or to an oxidant conveyor.

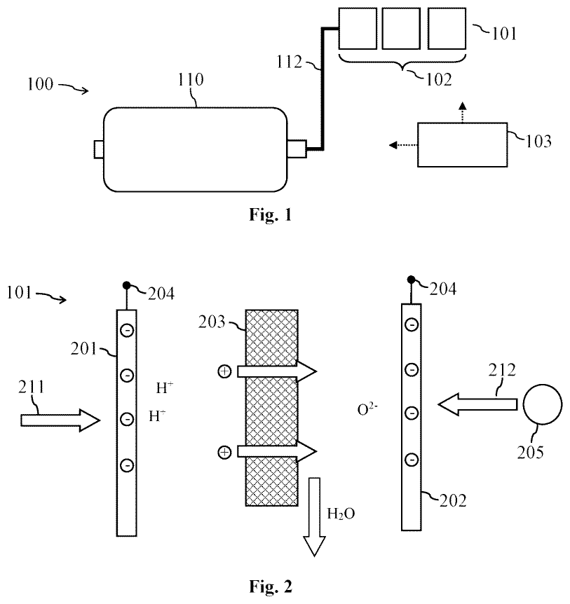

FIG. 1 shows a fuel cell system 100 having a fuel cell stack 102 having at least one fuel cell 101. The fuel cell system 100 is intended, for example, for mobile applications such as motor vehicles, especially for provision of energy for at least one electric engine for movement of a motor vehicle. A fuel cell 101 is an electrochemical energy converter that converts fuel and oxidant to reaction products, and in so doing produces electricity and heat. A fuel cell 101 comprises (as shown in FIG. 2) an anode 201 and a cathode 202 that are separated by an ion-selective or ion-permeable separator 203. The anode 201 is supplied with fuel 211. Preferred fuels 211 are: hydrogen (H₂), lower alcohol, biofuels, or liquefied natural gas. The cathode 202 is supplied with oxidant 212. Preferred oxidants 212 are: air, oxygen and peroxides. The ion-selective separator 203 may take the form, for example, of a proton exchange membrane (PEM). Preference is given to using a cation-selective polymer electrolyte membrane. Examples of materials for such a membrane are: Nafion®, Flemion® and Aciplex®.

A fuel cell system 100 comprises, as well as the at least one fuel cell 101, peripheral system components (BOP components) that can be used in the course of operation of the at least one fuel cell 101. In general, several fuel cells 101 are combined to form a fuel cell stack 102. In addition, the fuel cell system 100 typically comprises at least one pressure vessel, especially pressure tank, 110, which can be used to provide the fuel 211 for the one or more fuel cells 101. The pressure vessel 110 is connected to the one or more fuel cells 101 via one or more conduits 112. The electrical power provided by the fuel cell stack 102 may be controlled by open-loop and/or closed-loop control by a (control) apparatus 103 of the fuel cell system 100. In this connection, the mass flow rate of fuel 211 and/or oxidant 212 into the fuel cell stack 102 can be controlled by open-loop and/or closed-loop control. The mass flow rate of oxidant 212 can be adjusted and/or varied by means of an oxidant conveyor 205, especially by means of a compressor.

The anode 201 and the cathode 202 of a fuel cell 101 or of a fuel cell stack 102 may be connected to contact parts 204. There is typically an operating voltage between the contact parts 204 (for example about 1 V for a fuel cell 101), and it is possible to provide a current. Series connection of multiple fuel cells 101 (i.e. provision of a fuel cell stack 102) makes it possible to increase the operating voltage of a fuel cell stack 102.

The fuel cells 101 of the fuel cell stack 102 generally each comprise two separator plates (not shown). Each ion-selective separator 203 of a fuel cell 101 is generally disposed between two separator plates. One separator plate together with the ion-selective separator 203 forms the anode 201. Meanwhile, the further separator plate disposed on the opposite side of the ion-selective separator 203, together with the ion-selective separator 203, forms the cathode 202. There are preferably gas channels for fuel 211 and for oxidant 212 provided in the separator plates.

The separator plates may take the form of monopolar plates and/or of bipolar plates. In other words, a separator plate appropriately has two sides, where one side together with an ion-selective separator 203 forms the anode 201 of a first fuel cell 101, and where the second side together with a further ion-selective separator 203 of an adjacent second fuel cell 101 forms the cathode 202 of the second fuel cell 101.

In general, gas diffusion layers (GDL) are also provided between the ion-selective separators 203 and the separator plates.

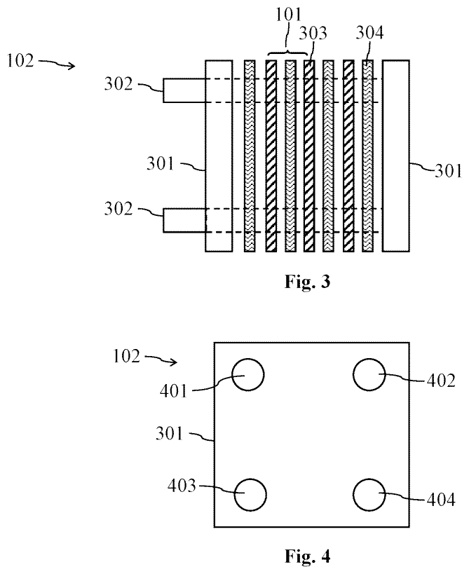

FIG. 3 shows the construction of an illustrative fuel cell stack 102 in a side view. The fuel cell stack 102 comprises end plates 301 between which multiple fuel cells 101 are disposed. The end plates 301 may be used to hold together, or press together, the fuel cells 101 of the fuel cell stack 102. As set out above, a fuel cell 101 may be formed by one side of each of two adjacent bipolar plates 303. Between two adjacent bipolar plates 303 may be disposed a membrane-electrode assembly (MEA) 304 that optionally comprises the abovementioned gas diffusion layer. Moreover, the fuel cell stack 102 comprises conduits 302 through which fuel 211 and/or oxidant 212 may be guided through the bipolar plates 303 to the individual fuel cells 101, and via which one or more reaction products (again via the bipolar plates 303) may be conducted out of the individual fuel cells 101.

In order to reduce build space, the accesses to the individual conduits 302 are typically only on one side of a fuel cell stack 102. FIG. 4 shows an illustrative fuel cell stack 102 in a front view. In particular, FIG. 4 shows the end plate 301 of a fuel cell stack 102, at which the accesses for the different conduits 302 of the fuel cell stack 102 are present. The fuel cell stack 102 may have a fuel inlet 401 via which fuel 211 can be conducted to the individual fuel cells 101. In addition, the fuel cell stack 102 may have an oxidant inlet 402 via which oxidant 212 can be conducted to the individual fuel cells 101. Moreover, the fuel cell stack 102 may have a reaction product outlet 403 via which reaction products from the fuel cells 101 can be removed (for example together with excess oxidant 212 or air). In addition, the fuel cell stack 102 may have a fuel outlet 404 via which unconsumed fuel 211 can be removed from the fuel cells 101 (for example in the course of an anode purge or in the course of fuel recirculation).

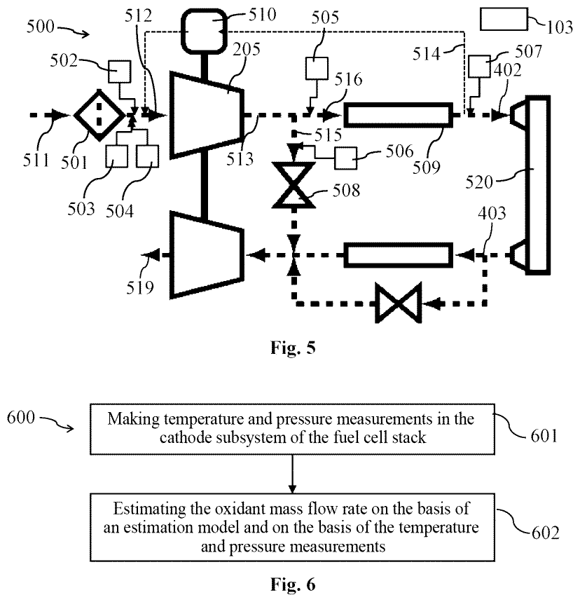

The fuel cell system 100 comprises, as shown by way of example in FIG. 5, a cathode subsystem 500 (with one or more cathode-side components), formed by the oxidant-conducting components of the fuel cell system 100. The cathode system 500 may have at least one oxidant conveyor 205, at least one cathode supply pathway that leads to the cathode inlet 402, at least one cathode offgas pathway that leads away from the cathode outlet 403, a cathode space 520 in the fuel cell stack 102 and/or further elements. The main function of the cathode subsystem 500 is the introduction and distribution of oxidant 212 to the electrochemically active surfaces of the cathode space 520, and the removal of unconsumed oxidant 212.

The cathode subsystem 500 may comprise an inlet 511 for oxidant 212 (for example for ambient air) on the cathode supply pathway. The oxidant 212 may then be filtered in an (air) filter 511 before the oxidant 212 is guided to the oxidant conveyor 205. The oxidant conveyor 205 may be driven by an (electric) motor 510. The motor 510 may have one or more motor bearings that are operated with oxidant 212 (rather than with lubricant) in order to avoid contamination of the cathode subsystem 500 and/or of the fuel cell stack 102. The oxidant 212 for operation of the motor 510 can be withdrawn from the cathode supply pathway via a bearing pathway 514.

At the input 512 of the oxidant conveyor 205 and/or at the output of the filter 501 may be disposed a physical mass flow rate sensor 502 configured to detect mass flow measurements \dot{m}_{AirFil}^{meas} in relation to the mass flow rate of oxidant 212 at the input 512 of the oxidant conveyor 205 and/or at the filter 501. In addition, a temperature sensor 503 and/or a pressure sensor 504 may be disposed at the input 512 of the oxidant conveyor 205 and/or at the output of the filter 501. The pressure sensor 504 may be configured to detect pressure measurements p_{Cmpr}ⁱⁿ in relation to the pressure of the oxidant 212 at the input 512 of the oxidant conveyor 205. The temperature sensor 503 may be configured to detect temperature measurements T_{AirFil}^{meas} in relation to the temperature of the oxidant 212 at the filter 501. As further detailed below, the temperature measurements T_{AirFil}^{meas} at the filter 501 may vary from the temperature T_{Cmpr}ⁱⁿ of the oxidant 212 at the input 512 of the oxidant conveyor 205 (because of the oxidant mass flow rate out of the one or more bearings of the motor 510 of the oxidant conveyor 205).

The cathode subsystem 500 may also have a pressure sensor 505 at the output 513 of the oxidant conveyor 205. The pressure sensor 505 may be configured to detect pressure measurements pomp, in relation to the pressure of the oxidant 212 at the output 513 of the oxidant conveyor 205. The oxidant 212 may be conveyed to the cathode space 520 by means of an oxidant cooler 509. At the output of the oxidant cooler 509 may also be disposed a branch of oxidant 212 to the bearing pathway 514. Of the mass flow of oxidant 212 at the output of the oxidant cooler 509, it is thus possible to conduct a (relatively large) portion into the cathode space 520 and a (complementary) portion to the one or more bearings of the motor 510 of the oxidant conveyor 205.

At the output of the oxidant cooler 509, there may be disposed a temperature sensor 507 configured to detect temperature measurements T_{AirBear}ⁱⁿ in relation to the temperature of the oxidant 212 at the output of the oxidant cooler 509 and/or at the input to the one or more bearings of the motor 510.

The reaction product outlet 403 from the cathode space 520 may be directed to the outlet 519 of the cathode subsystem 500. In addition, the cathode subsystem 500 may have a bypass pathway 515 for oxidant 212 that runs from the output 513 of the oxidant conveyor 205 to the outlet 519 of the cathode subsystem 500, in order to be able to route excess oxidant 212 (for example in the case of startup of the fuel cell stack 102) directly out of the cathode subsystem 500. On the bypass pathway 515, there may be disposed a physical mass flow sensor 506 (for measurement of the mass flow rate of oxidant 212 on the bypass pathway 515) and/or a bypass valve 508 (for control of the mass flow rate of oxidant 212 on the bypass pathway 515). When the bypass valve 508 is open, a portion of the oxidant 212 at the output 513 from the oxidant conveyor 205 flows into the inlet 516 to the oxidant cooler 509, and a complementary portion into the bypass pathway 515.

The mass flow rate of oxidant 212 into the cathode space 520 can be controlled by open-loop or closed-loop control using the mass flow rate measurements from the physical mass flow rate sensor 502 in order to ascertain the actual mass flow rate value. However, mass flow rate measurements are typically subject to a relatively high level of noise, especially in the case of relatively high mass flow rate values, which leads to impairment of the accuracy and/or dynamics of the open-loop and or closed-loop control of the mass flow rate, and hence to impairment of the power dynamics of the fuel cell stack.

The (control) apparatus 103 of the fuel cell system 100 may be configured, using a base estimation model of the oxidant conveyor 205, to estimate the value \dot{m}_{Cmpr} of the oxidant mass flow rate through the oxidant conveyor 205. An illustrative basis estimation model is:

$${\dot{m}}_{Cmpr} = {\dot{\tilde{m}}}_{Cmpr} \frac{{δ}_{Cmpr}^{i n}}{\sqrt{{θ}_{Cmpr}^{i n}}}$$

$${δ}_{Cmpr}^{i n} = \frac{{p}_{Cmpr}^{i n}}{{p}^{ref}}$$

$${θ}_{Cmpr}^{i n} = \frac{{T}_{Cmpr}^{i n}}{{R}^{ref}}$$

where p^{ref} is a reference pressure (e.g. p^{ref}=1 bar) and T^{ref} is a reference temperature (e.g. T^{ref}=298.15 K) (defined by the reference conditions). The normalized mass flow rate \tilde{\dot{m}}_{Cmpr} can be found as follows:

$${\dot{\tilde{m}}}_{Cmpr} = {Φ}_{Cmpr} {ρ}_{Air}^{ref} \frac{π}{4} {d}_{Cmpr}^{2} {U}_{c}$$

$${Φ}_{Cmpr} = \frac{{k}_{3} {Ψ}_{Cmpr} - {k}_{1}}{{k}_{2} + {Ψ}_{Cmpr}}$$

$${U}_{c} = \frac{π}{60} {d}_{Cmpr} {\tilde{n}}_{Cmpr}$$

where d_{Cmpr} is the diameter of the oxidant conveyor 205, where ρ_{Air}^{ref} is the density of the oxidant 205 under the reference conditions (e.g. ρ_{Air}^{ref}=1.1638 kg/m³), where Φ_{Cmpr} is the normalized mass flow rate, where ψ_{Cmpr} is a dimensionless parameter for description of the oxidant conveyor 205, where kᵢ, with i=1, . . . , 3, are fitting parameters, where U_{c} is the outside speed of the rotor of the oxidant conveyor 205, and where ñ_{Cmpr} is the normalized speed of rotation of the oxidant conveyor 205. The diameter of the oxidant conveyor 205 may be, for example, d_{Cmpr}=0.06 m.

The parameters ψ_{Cmpr} for description of the oxidant conveyor 205 can be ascertained via

$${Ψ}_{Cmpr} = \frac{{2}_{{C}_{p , Air}} {T}^{ref} [ {( \frac{{p}_{Cmpr}^{out}}{{p}_{Cmpr}^{i n}} )}^{\frac{{γ}_{Air} - 1}{{γ}_{Air}}} - 1 ]}{{U}_{C}^{2}}$$

$${k}_{i} = {k}_{i , 1} + {k}_{i , 2} \times {Ma}_{Cmpr}$$

where c_{p,Air}=1015 J/(kg·K) and where γ_{Air}=1.4. The parameter Mα_{Cmpr} can be calculated via

$${Ma}_{Cmpr} = \frac{{U}_{c}}{\sqrt{{γ}_{Air} {R}_{Air} {T}^{ref}}}$$

where the gas constant of the oxidant 212 is, for example, R_{Air}=288.19 J/(kg·K). The fitting parameters can be ascertained experimentally by measurements on the oxidant conveyor 205, for example as

$${k}_{i , j} [ \begin{matrix}0.1557 & 0.0176 \\ - 1.5296 & 0.0843 \\ 0.1242 & 0.0112\end{matrix} ]$$

The normalized speed of rotation ñ_{Cmpr} can be ascertained on the basis of the speed of rotation n_{Cmpr} of the oxidant conveyor 205 (which can be detected by a sensor) as

$${\tilde{n}}_{Cmpr} = {n}_{Cmpr} \frac{1}{\sqrt{{θ}_{Cmpr}^{i n}}}$$

As set out further up, the oxidant conveyor 205 may comprise a motor 510 with one or more motor bearings that are operated with oxidant 212 that has been conveyed by the oxidant conveyor 205. It is thus possible to branch off a proportion of the oxidant mass flow at the output 513 of the oxidant conveyor 205 for the bearing pathway 514 to the one or more bearings. The mass flow rate \dot{m}_{AirBear} on the bearing pathway 514 can be ascertained using a supplementary estimation model for the one or more bearings, for example as

$${\dot{m}}_{AirBear} = {C}_{AirBear} \sqrt{\frac{{p}_{AirBear}^{i n}}{{R}_{Air} {T}_{AirBear}^{i n}} ( {p}_{AirBear}^{i n} - {p}_{AirBear}^{out} )}$$

where p_{AirBear}ⁱⁿ is the pressure of the oxidant 212 at the input of the one or more bearings, where p_{AirBear}^{out} is the pressure of the oxidant 212 at the output of the one or more bearings, where T_{AirBear}ⁱⁿ is the temperature of the oxidant 212 at the input of the one or more bearings, and where the experimentally ascertained fitting parameter C_{AirBear} is, for example, C_{AirBear}=8.76·10⁻⁶ m². It can be assumed here that p_{AirBear}ⁱⁿ corresponds to the value p_{Cmpr}^{out} measured by the pressure sensor 505 and/or that P_{AirBear}^{out} corresponds to the value p_{Cmpr}ⁱⁿ measured by the pressure sensor 504.

As set out further up, for the model of the oxidant conveyor 205, the value of the temperature T_{Cmpr}ⁱⁿ of the oxidant 212 at the input 512 of the oxidant conveyor 205 is required. Because of the fact that the mass flow rate at the input 512 of the oxidant conveyor 205 is a mixture of the oxidant mass flow rate through the filter 501 and the oxidant mass flow rate from the one or more bearings, the temperature T_{Cmpr}ⁱⁿ of the oxidant 212 at the input 512 of the oxidant conveyor 205 may vary from the temperature measurement T_{AirFil}^{meas} by the temperature sensor 503. The temperature T_{Cmpr}ⁱⁿ of the oxidant 212 at the input 512 of the oxidant conveyor 205 can be ascertained as

$${T}_{Cmpr}^{i n} = \frac{{\dot{m}}_{AirFil}^{meas}}{{\dot{m}}_{AirFil}^{meas} + {\dot{m}}_{AirBear}^{calc}} {T}_{AirFil}^{meas} + \frac{{\dot{m}}_{AirBear}^{calc}}{{\dot{m}}_{AirFil}^{meas} + {\dot{m}}_{AirBear}^{calc}} {T}_{AirBear}^{out}$$

where T_{AirBear}^{out} is the temperature of the oxidant mass flow rate at the output of the one or more bearings of the motor 510 of the oxidant conveyor 205. It is thus possible to take a weighted average of the temperature measurements T_{AirBear}^{out} and T_{AirFil}^{meas} in order to ascertain the temperature T_{Cmpr}ⁱⁿ. The weights depend on the respective proportion of the overall oxidant mass flow rate \dot{m}_{AirBear}+\dot{m}_{AirFil}^{meas} at the input 512 of the oxidant conveyor 205. The temperature T_{AirBear}^{out} can be equated to the measured temperature of the motor 510. \dot{m}_{AirFil}^{meas} is the mass flow rate measurement of the mass flow rate sensor 502. \dot{m}_{AirBear}^{calc}=\dot{m}_{AirBear} is the estimate of the oxidant mass flow rate on the bearing pathway 514.

The apparatus 103 may thus be configured, on the basis of the temperature and/or pressure measurements from one or more sensors 503, 504, 505, 507, to estimate a value \dot{m}_{Cmpr} of the oxidant mass flow rate through the oxidant conveyor 205. In addition, it is possible to estimate a value \dot{m}_{AirBear} of the oxidant mass flow rate branched off therefrom for the bearing pathway 514. On that basis, especially based on the difference \dot{m}_{Kat}=\dot{m}_{Cmpr}−\dot{m}_{AirBear}, it is possible to ascertain the oxidant mass flow rate into the cathode space 520. Thus, especially in the case of relatively high mass flow rate values, precise open-loop and/or closed-loop control of the oxidant mass flow rate \dot{m}_{Kat} into a fuel cell stack 102 can be enabled.

The apparatus 103 may be configured to compare the mass flow rate measurement \dot{m}_{AirFil}^{meas} from the physical mass flow rate sensor 502 with a mass flow rate threshold value \dot{m}ₜₕᵣₑₛ. Alternatively or additionally, the apparatus 103 may be configured to compare the rotation rate and/or speed of rotation of the oxidant conveyor 205 with a corresponding threshold value. The use of the rotation rate and/or speed of rotation is typically advantageous because sensor noise is relatively low. When \dot{m}_{AirFil}^{meas}≤\dot{m}ₜₕᵣₑₛ and/or when the rotation rate or speed of rotation is less than or equal to the threshold value, the mass flow rate measurement \dot{m}_{AirFil}^{meas} may be used for open-loop and/or closed-loop control of the oxidant mass flow rate. On the other hand, when \dot{m}_{AirFil}^{meas}>\dot{m}ₜₕᵣₑₛ and/or when the rotation rate or speed of rotation is greater than the threshold value, it is (alternatively or additionally) possible to use the estimate \dot{m}_{Cmpr} for the oxidant mass flow rate for open-loop and/or closed-loop control of the oxidant mass flow rate. In this way, it is possible to enable particularly robust, precise and dynamic open-loop and/or closed-loop control of the oxidant mass flow rate.

As already set out further up, the closed-loop control system for air mass flow rate in a fuel cell system 100 controls the air mass flow rate typically via alteration of the rotation rate or speed of rotation of the compressor 205. The closed-loop controller in a vehicle should be designed to maximally exploit the dynamics of the compressor 205 in order to be able to react in the best way possible to rapid changes in load while the vehicle is travelling. For comparison of target and actual values, it is possible to use a physical mass flow rate sensor 502 installed upstream of the compressor 205. In this case, the relatively high level of noise in the sensor signal from the mass flow rate sensor 502 in the case of high loads can lead to relatively frequent acceleration and deceleration of the compressor 205. As a relatively large electrical consumer of electrical power in the fuel cell system 100, relatively frequent alteration of the compressor speed can lead to relatively significant fluctuations in the electrical power of the fuel cell system 100. The use of signal filters for reduction of sensor noise (for example the use of a moving average) typically has the effect that the dynamics of the mass flow rate signal from the mass flow rate sensor 502 are distorted.

The closed-loop control system for air mass flow rate is typically based solely on the mass flow rate sensor 502, as a result of which, in the event of failure of the sensor 502, there is no way of continuing to control the air mass flow rate. Moreover, there is no way of testing the sensor values from the mass flow rate sensor 502 for plausibility since it is not usually possible to install a second physical sensor for reasons of space and cost. The measures described in this document make it possible to estimate the oxidant mass flow rate, which can be used as a replacement, as an addition and/or for plausibilization of the measurements from the mass flow rate sensor 502.

It is thus possible to use a virtual sensor (for estimation of the oxidant mass flow rate) additionally or alternatively to the physical mass flow rate sensor 502. The (estimation) model of the virtual sensor is based on physical principles of action, as a result of which the model is independent of the operating state and of the system construction, and can be parametrized by measurements on the component testbed (of the compressor 205). The physical sensors 503, 504, 505, 507 used for calculation of the estimate from the virtual sensor typically have a much greater signal-to-noise ratio than the physical mass flow rate sensor 502, which means that the virtual mass flow rate sensor (i.e. the estimated oxidant mass flow rate) also has a much greater signal-to-noise ratio. While the virtual sensor is used for closed-loop control of the oxidant mass flow rate, the physical sensor 502 can be used (possibly only) for plausibilization of the estimates.

The base model used may be the semiempirical compressor model described in this document, which has empirically determined fitting parameters for example. In addition, it is possible to use a supplementary model for the air mass flow rate through the air bearing of the compressor 205. The virtual sensor value can be calculated using the values from physical pressure sensors 504, 505, temperature sensors 503, 507 and/or a speed sensor. These sensors typically have much lower signal noise than the physical mass flow rate sensor 502. Parametrization of the (base) model can be conducted via measurements on the compressor testbed.

Closed-loop control of air mass flow rate based on the estimated mass flow rate can be used to stabilize the power input via the compressor 205, which can increase the dynamics of the fuel cell system 100.

FIG. 6 shows a flow diagram of an (optionally computer-implemented) method 600 of estimating a mass flow rate of oxidant 212 into an electrochemical energy converter 102 (especially into a fuel cell stack), wherein the oxidant mass flow rate is brought about by an oxidant conveyor 205 (especially by a compressor). The method 600 may also be designed to control the oxidant mass flow rate into the energy converter 102 (on the basis of the estimate) by open-loop and/or closed-loop control.

The method 600 comprises the detecting 601, using temperature and pressure sensors 503, 504, 505, 507, of temperature and pressure measurements on the oxidant pathway to the energy converter 102 on which the oxidant conveyor 205 is disposed. The oxidant pathway may run from an inlet 511 for oxidant 212 to a feed 402 to the energy converter 102. The temperature and pressure sensors 503, 504, 505, 507 may be disposed on the oxidant pathway. The oxidant pathway may be part of the cathode subsystem 500 of a fuel cell stack 102 which is described in this document.

The method 600 further comprises the estimating 602, on the basis of the temperature and pressure measurements, using a base estimation model (for the oxidant conveyor 205), of the oxidant mass flow rate (e.g. \dot{m}_{Cmpr}) conveyed by the oxidant conveyor 205, especially an estimated oxidant mass flow rate (e.g. \dot{m}ₖₐₜ) flowing into the energy converter 102.

By virtue of the measures described in this document, it is possible to estimate the oxidant mass flow rate of a fuel cell stack 102 in an efficient and precise manner, which can increase the power dynamics of the fuel cell stack 102.

The present invention is not limited to the working examples detailed. In particular, it should be noted that the description and the figures are intended to illustrate the principle of the proposed methods, apparatuses and systems merely by way of example.

### LIST OF REFERENCE NUMERALS

100 fuel cell system
101 fuel cell
102 fuel cell stack
103 (control) apparatus
110 pressure vessel
112 fuel conduit
201 anode
202 cathode
203 separator
204 contact part (electrode)
205 oxidant conveyor
211 fuel (especially hydrogen)
212 oxidant (especially air)
301 end plate
302 conduit
303 bipolar plate
304 electrode-membrane unit
401 fuel inlet
402 oxidant inlet
403 reaction product outlet
404 anode gas outlet
500 cathode subsystem
501 oxidant filter
502 physical mass flow rate sensor
503 temperature sensor
504 pressure sensor
505 pressure sensor
506 physical mass flow rate sensor
507 temperature sensor
508 bypass valve
509 oxidant cooler
510 motor (oxidant conveyor)
511 inlet (cathode subsystem)
512 input (oxidant conveyor)
513 output (oxidant conveyor)
514 bearing pathway
515 bypass pathway (oxidant)
516 feed to the oxidant cooler
519 outlet (cathode subsystem)
520 cathode space
600 method of ascertaining the oxidant mass flow rate
601-602 method steps

1.-10. (canceled)

11. An apparatus for estimating a mass flow rate of oxidant into an electrochemical energy converter, wherein oxidant mass flow is brought about by an oxidant conveyor, the apparatus comprising:
a vehicle controller operatively configured to:
detect, using temperature and pressure sensors, temperature and pressure measurements on an oxidant pathway to the energy converter on which the oxidant conveyor is disposed; and
use the temperature and pressure measurements as a basis, via a base estimation model, for estimating the oxidant mass flow rate conveyed by the oxidant conveyor that flows into the energy converter.

12. The apparatus according to claim 11, wherein the controller is further configured to:
operate the oxidant conveyor as a function of the estimated oxidant mass flow rate, in order to adjust the oxidant mass flow rate to a target value; and/or
verify a mass flow rate measurement from a physical mass flow rate sensor on the oxidant pathway using the estimated oxidant mass flow rate.

13. The apparatus according to claim 11, wherein
the base estimation model is dependent on one or more properties of the oxidant conveyor, and
the one or more properties of the oxidant conveyor include:
a speed of rotation of a rotor of the oxidant conveyor; and/or
a cross section and/or a diameter of the oxidant conveyor.

14. The apparatus according to claim 13, wherein
the base estimation model comprises one or more fitting parameters for which parameter values have been ascertained using measurements at the oxidant conveyor.

15. The apparatus according to claim 11, wherein the temperature and pressure measurements include:
a pressure measurement of a pressure at an input of the oxidant conveyor;
a pressure measurement of a pressure at an output of the oxidant conveyor; and
a temperature measurement of a temperature at the input of the oxidant conveyor.

16. The apparatus according to claim 11, wherein
the oxidant conveyor comprises a motor having one or more motor bearings operated with oxidant that has been conveyed by the oxidant conveyor;
an oxidant mass flow rate for operation of the one or more motor bearings is branched off from a branch point between an output of the oxidant conveyor and the energy converter; and
the controller is further operatively configured to:
use the temperature and pressure measurements as a basis, using a supplementary estimation model, to estimate the oxidant mass flow rate for operation of the one or more motor bearings; and
estimate the oxidant mass flow rate flowing into the energy converter on the basis of the estimated oxidant mass flow rate for operation of the one or more motor bearings.

17. The apparatus according to claim 16, wherein the temperature and pressure measurements comprise:
a pressure measurement in relation to a pressure of the oxidant at an input of the one or more motor bearings,
a pressure measurement in relation to a pressure of the oxidant at the output of the one or more motor bearings, and
a temperature measurement in relation to a temperature of the oxidant at the input of the one or more motor bearings.

18. The apparatus according to claim 16, wherein the controller is further operatively configured to:
estimate the oxidant mass flow rate flowing into the energy converter on the basis of the estimated oxidant mass flow rate conveyed by the oxidant conveyor and on the basis of the estimated oxidant mass flow rate for operation of the one or more motor bearings.

19. The apparatus according to claim 11, wherein
the oxidant conveyor comprises a motor having one or more motor bearings that are operated with oxidant that has been conveyed by the oxidant conveyor;
an oxidant mass flow rate for operation of the one or more motor bearings is fed back into the oxidant pathway at a feed point between an input of the oxidant conveyor and an oxidant filter; and
the controller is further operatively configured to:
make a measurement of a temperature of the oxidant at the input of the oxidant conveyor on the basis of a measured temperature of the motor; and
estimate the oxidant mass flow rate conveyed by the oxidant conveyor on the basis of the measured temperature of the oxidant at the input of the oxidant conveyor.

20. A method of estimating a mass flow rate of oxidant into an electrochemical energy converter, wherein the oxidant mass flow is brought about by an oxidant conveyor; the method comprising:
detecting, using temperature and pressure sensors, temperature and pressure measurements on an oxidant pathway to the energy converter on which the oxidant conveyor is disposed; and
estimating, on the basis of the temperature and pressure measurements, using a base estimation model, the oxidant mass flow rate conveyed by the oxidant conveyor.

21. The method according to claim 20, wherein an estimated oxidant mass flow rate is that flowing into the energy converter.
